(19) United States
(12) Patent Application Publication
(10) Pub. No.: US 2013/0141470 A1
(43) Pub. Date: Jun. 6, 2013

(54) Pixel Matrix, Array Substrate, Liquid Crystal Display Device and Driving Method

(71) Applicant: Zui Wang, Shenzhen (CN)

(72) Inventor: Zui Wang, Shenzhen (CN)

(21) Appl. No.: 13/378,545

(22) PCT Filed: Dec. 6, 2011
(86) PCT No.: PCT/CN11/83539

§ 371 Date: Dec. 15, 2011

(30) Foreign Application Priority Data
Dec. 2, 2011 (CN) 2011103961295

(51) Int. Cl. G09G 5/10; G09G 3/36; G09G 3/20

(52) U.S. Cl. 345/690; 345/55; 345/87

(57) ABSTRACT

The present invention discloses a pixel matrix, an array substrate, a liquid crystal display device and a driving method. A pixel matrix comprises a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors. Each row comprises said sub-pixels of more than two colors. In the present invention, a plurality of sub-pixel electrodes are corresponding to different colors in each row of matrix, so when under solid color drive or two-solid color mixture drive, if the matrix in the current row is under drive, not all the gate lines are needed to open, so that the load of data scanning chip in the same chronology is reduced so as to further reduce the temperature of the data chip and extend the service life of the data chip.

### TECHNICAL FIELD

The present invention relates to the field of liquid crystal display, and more specifically relates to a pixel matrix, an array substrate, a liquid crystal display device and a driving method.

### BACKGROUND

A liquid crystal display device comprises a plurality of sub-pixels respectively corresponding to three primary colors, wherein every three adjacent sub-pixels can form one display pixel. An existing pixel matrix adopts a tri-gate design, i. e. red-green-blue sub-pixels are circularly arranged in the vertical direction to ensure that the number of the gate lines=vertical resolution×3 and the number of the gate lines=horizontal resolution.

Adopting the tri-gate design can reduce the number of COF so as to reduce the cost. The common tri-gate design is shown in FIG. 1: pixels of the same color are arranged in the horizontal direction, and pixels of red-green-blue colors are circularly arranged in the vertical direction; one gate line crossly charges two adjacent rows of pixels respectively, which is called as an point flip pixel connection mode; the data signals are shown in FIG. 2. The signal load in the design is larger, and the red-green-blue solid color picture becomes heavily loaded picture so that the temperature of the data chip is higher and the service life of the data chip is reduced.

### SUMMARY

The aim of the present invention is to provide a pixel matrix, an array substrate, a liquid crystal display device and a driving method which have the advantages of reduce the temperature of the data chip and extend the service life of the data chip.

The purpose of the present invention is achieved by the following technical schemes:

A pixel matrix comprises a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors. Each row comprises said sub-pixels of more than two colors.

Preferably, a plurality of said sub-pixels in each row and each line are repeatedly arranged in the order of the first sub-pixels, the second sub-pixels and the third sub-pixels. In the embodiment mode, colors corresponding to two adjacent sub-pixels in the row and the line are not coincident, and colors of the sub-pixels on −45-degree slash are almost same. When display in solid colors, no matter in the mode of row scanning or line scanning, only ⅓ data signals are required to work in the same chronology, so that the working condition is obviously improved as compared with the original working condition with full load.

Preferably, a plurality of said sub-pixels in each line are repeatedly arranged in the order of the first sub-pixels, the third sub-pixels and the second sub-pixels; and a plurality of said sub-pixels in each line are repeatedly arranged in the order of the first sub-pixels, the second sub-pixels and the third sub-pixels.

In the embodiment mode, colors corresponding to two adjacent sub-pixels in the row and the line are not coincident, and colors of the sub-pixels on 45-degree slash are almost same. When display in solid colors, no matter in the mode of row scanning or line scanning, only ⅓ data signals are required to work in the same chronology, so that the working condition is obviously improved as compared with the original working condition with full load.

Preferably, a plurality of sub-pixels in each row are repeatedly arranged in the order of at least two first sub-pixels, at least two second sub-pixels and at least two third sub-pixels. This is the arrangement mode of the third kind of pixel matrix.

Preferably, a plurality of said sub-pixels in each row are repeatedly arranged in the order of one first sub-pixel, and one second sub-pixels. This is the arrangement mode of the fourth kind of pixel matrix.

Preferably, a plurality of the sub-pixels in each row are repeatedly arranged in the order of three first sub-pixels, and three second sub-pixels. This is the arrangement mode of the fifth kind of pixel matrix.

An array substrate comprises a plurality of scanning lines and a plurality of gate lines, wherein the scanning lines are crossed with the gate lines to form a plurality of rectangular areas; each rectangular area is correspondingly provided with one sub-pixel; the sub-pixels are arranged to form the pixel matrix.

Preferably, each gate line alternatively powers sub-pixel electrodes on both sides. This is a driving mode based on tri-gate; one gate line can respectively powers two rows of sub-pixel electrodes so that the quantity of the data chip is reduced and the cost is saved.

A liquid crystal display device, comprising an array substrate.

A driving method of the pixel matrix, wherein when under drive of each scanning line, the gate line corresponding to the sub-pixel electrode of the corresponding color in the current row is driven. When the technical scheme is used in solid color scanning, two chronologies can last in one data scanning cycle, and compared with the original scheme one chronology is increased; therefore, the scanning frequency of the data chip is reduced by half and the power consumption of the data chip is further reduced so as to reduce the temperature of the data chip and extend the service life of the data chip.

In the present invention, a plurality of sub-pixel electrodes are corresponding to different colors in each row of matrix, so when under solid color drive or two-solid color mixture drive, if the matrix in the current row is under drive, not all the gate lines are needed to open, so that the load of data scanning chip in the same chronology is reduced so as to further reduce the temperature of the data chip and extend the service life of the data chip.

### DESCRIPTION OF FIGURES

FIG. 1 is a schematic diagram of the existing pixel matrix.

FIG. 2 is a schematic diagram of the existing data signal.

FIG. 3 is the schematic diagram of the pixel matrix of the embodiment 1 of the present invention.

FIG. 4 is the schematic diagram of the pixel matrix of the embodiment 2 of the present invention.

FIG. 5 is a schematic diagram of the data signal of the present invention.

FIG. 6 is a schematic diagram of the data wave form of the driving solid-color signal of the present invention.

FIG. 7 is a schematic diagram of the data wave form of the driving color mixture signal of the present invention.

FIG. 8 is the schematic diagram of the pixel matrix of the embodiment 3 of the present invention.

FIG. 9 is the schematic diagram of the pixel matrix of the embodiment 4 of the present invention.

FIG. 10 is the schematic diagram of the pixel matrix of the embodiment 5 of the present invention.

Wherein: 1, first sub-pixel; 2, second sub-pixel; 3, third sub-pixel; GL1 to 6: scanning line; DL0 to 6: gate line.

### DETAILED DESCRIPTION

The present invention is further described by figures and the preferred embodiments as follows.

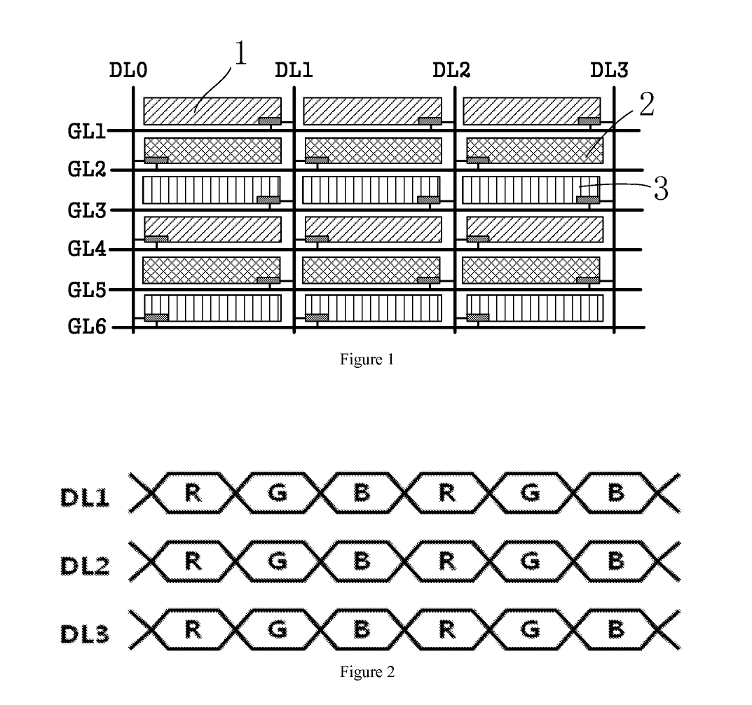

As shown in FIGS. 1 to 7, a liquid crystal display device comprises an array substrate, wherein the array substrate comprises a plurality of scanning lines and a plurality of gate lines; the scanning lines are crossed with the gate lines to form a plurality of rectangular areas; each rectangular area is correspondingly provided with one sub-pixel; the sub-pixels are vertically and horizontally arranged to form one pixel matrix; the sub-pixels are distinguished in colors, and comprise a plurality of first sub-pixels 1, a plurality of second sub-pixels 2 and a plurality of third sub-pixels 3 which are respectively corresponding to three primary colors; each row comprises said sub-pixels of more than two colors. The conception of the present invention is further interpreted by the following example, wherein first sub-pixels 1 correspond to red (R), second sub-pixels 2 correspond to green (G), and second sub-pixels 3 correspond to blue (B).

### Embodiment 1

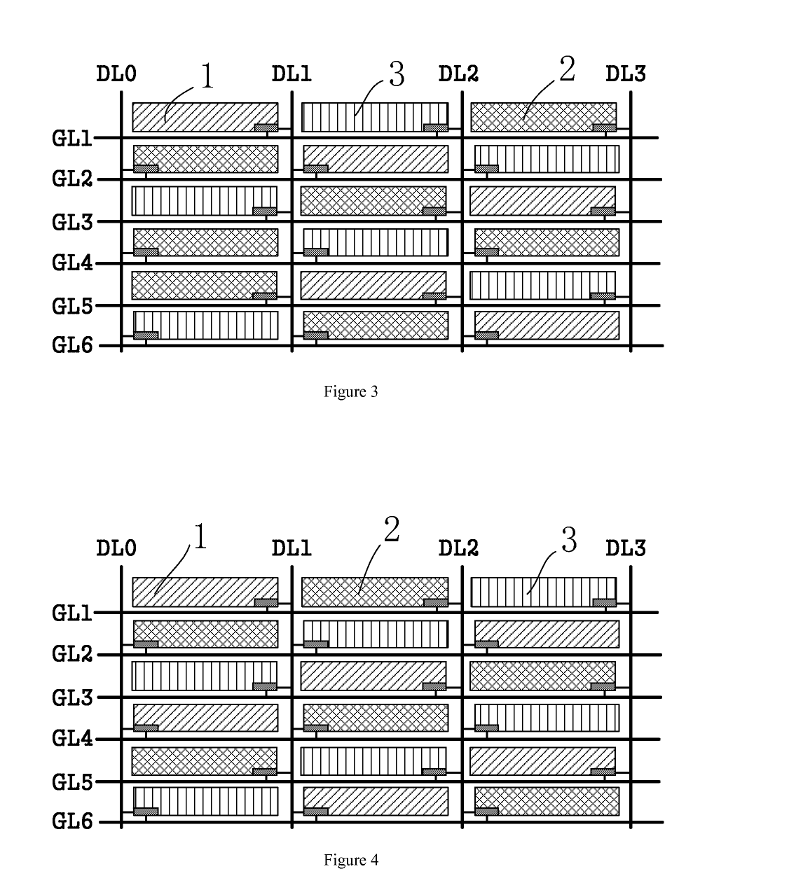

A shown in FIG. 3, sub-pixels in each row are repeatedly arranged in the order of R, B, and G, and sub-pixels in each line are repeatedly arranged in the order of R, G, and B, i. e. horizontally and vertically adjacent pixels have different colors, and sub-pixels on the −45-degree slash have the same color. If the sub-pixels in the current row is R, sub-pixels in the corresponding row are repeatedly arranged in the order of R, B, and G; if the sub-pixel in the current row is G, G is followed by R and B in accordance with the order of R, B, and G, so that the sub-pixel in the corresponding row are repeatedly arranged in the order of G, R, and B. No example is given as the arrangement in the line is the same as the arrangement in the row.

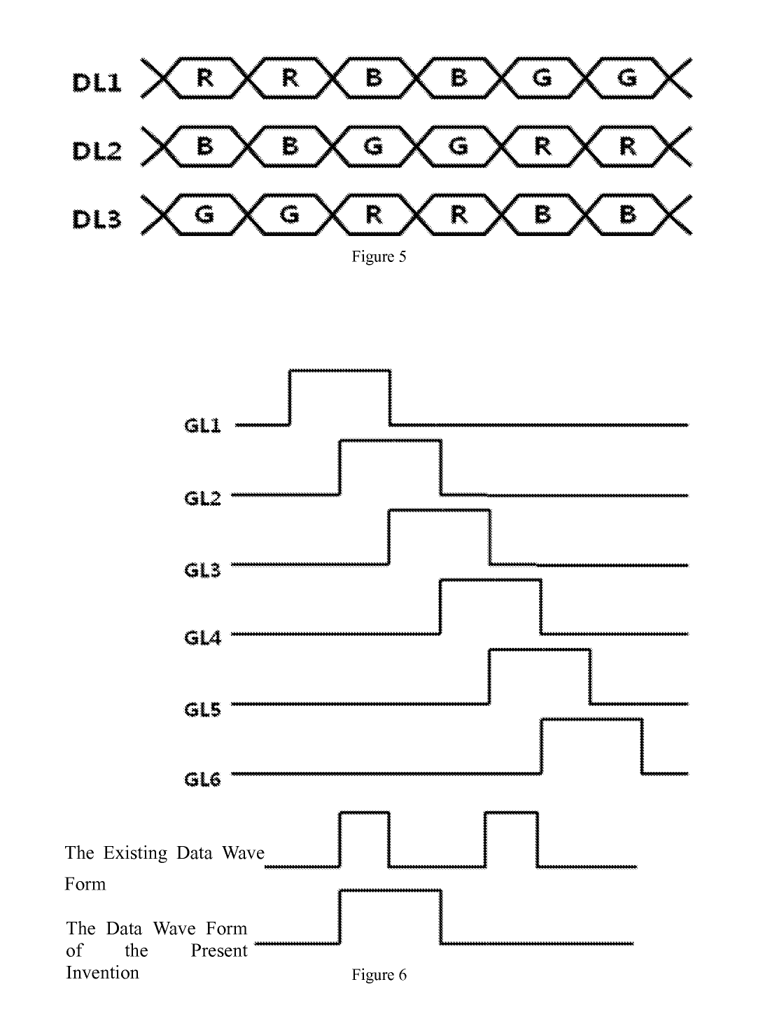

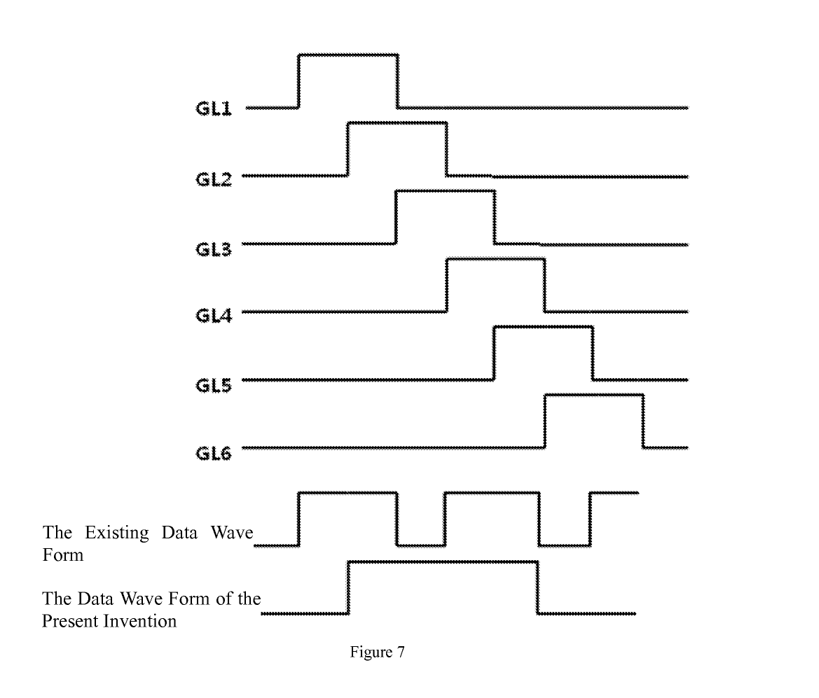

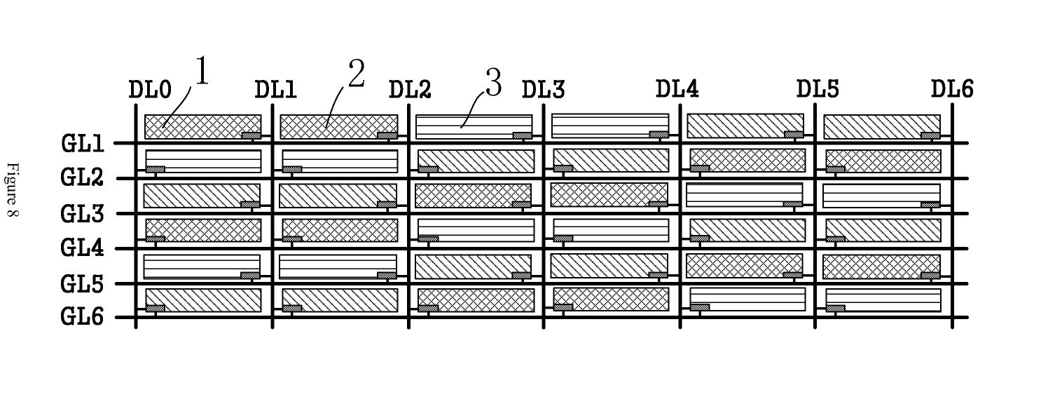

The driving design is designed in accordance with tri-gate. When the pixel matrix of the embodiment displays the solid color, the data signal is shown as FIG. 5, and the wave form is shown in FIG. 6; when the pixel matrix displays in a single color, the data signal of the corresponding gate line lasts two chronologies, so that the switch frequency is reduced by half as compared with the original driving mode; thus the energy consumption is further reduced, the temperature of the data chip is reduced and the service life of the data chip is extended; When the pixel matrix displays in the color mixture (R+B, R+G, and B+G), the corresponding data signal wave form is shown in FIG. 7; the data signal lasts four chronologies, so that the switch frequency is also reduced by half as compared with the original driving mode; thus the energy consumption is further reduced, the temperature of the data chip is reduced and the service life of the data chip is extended.

### Embodiment 2

A shown in FIG. 4, sub-pixels in each row and each line are repeatedly arranged in the order of R, G, and B, i. e. horizontally and vertically adjacent pixels have different colors, and sub-pixels on the 45-degree slash have the same color. If the sub-pixels in the current row is R, sub-pixels in the corresponding row are repeatedly arranged in the order of R, G, and B; if the sub-pixel in the current row is G, G is followed by B and R in accordance with the order of R, G, and B, so that the sub-pixel in the corresponding row are repeatedly arranged in the order of G, B, and R. No example is given as the arrangement in the line is the same as the arrangement in the row.

The driving design is designed in accordance with tri-gate. When the pixel matrix of the embodiment displays the solid color, the data signal is shown as FIG. 5, and the wave form is shown as FIG. 6; when the pixel matrix displays in a single color, the data signal of the corresponding gate line lasts two chronologies, so that the switch frequency is reduced by half as compared with the original driving mode; thus the energy consumption is further reduced, the temperature of the data chip is reduced and the service life of the data chip is extended. When the pixel matrix displays in the color mixture (R+B, R+G, and B+G), the corresponding data signal wave form is shown in FIG. 7; the data signal lasts four chronologies, so that the switch frequency is also reduced by half as compared with the original driving mode; thus the energy consumption is further reduced, the temperature of the data chip is reduced and the service life of the data chip is extended.

### Embodiment 3

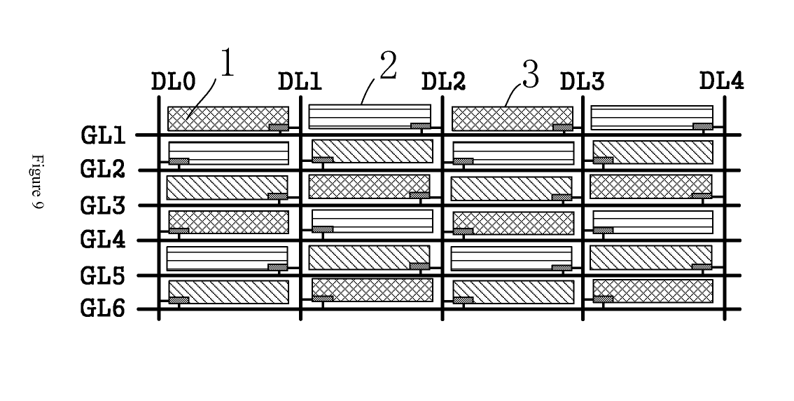

As shown in FIG. 8, sub-pixels in each row are repeatedly arranged in the order of more than two R, more than two G, and more than two B. The specific arrangement order is not limited to R, G, and B, and the forms of R−B−G, G−R−B, etc. can also be used.

### Embodiment 4

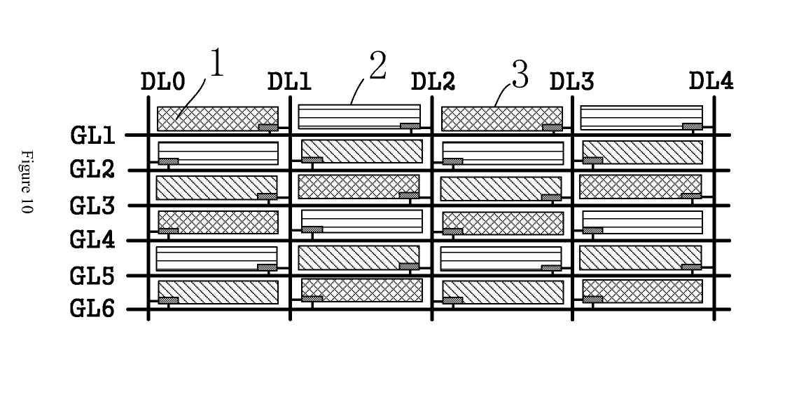

As shown in FIG. 9, sub-pixels in each row are repeatedly arranged in the order of one R, and one G The specific arrangement order is not limited to the combination of R and G, and the combination of R and B, or G and B can also be used.

### Embodiment 5

As shown in FIG. 10, sub-pixels in each row are repeatedly arranged in the order of more than two R, and more than two G. The specific arrangement order is not limited to the combination of R and G, and the combination of R and B, or G and B can also be used.

The above content is detailed description of the present invention by using specific preferred embodiments. However, this present invention is not limited to these specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A pixel matrix, comprising: a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors; each row comprises said sub-pixels of more than two colors.

2. The pixel matrix of claim 1, wherein a plurality of said sub-pixels in each row and each line are repeatedly arranged in the order of first sub-pixels, second sub-pixels and third sub-pixels.

3. The pixel matrix of claim 1, wherein a plurality of said sub-pixels in each line are repeatedly arranged in the order of the first sub-pixels, the third sub-pixels and the second sub-pixels; a plurality of said sub-pixels in each line are repeatedly arranged in the order of the first sub-pixels, the second sub-pixels and the third sub-pixels.

4. The pixel matrix of claim 1, wherein a plurality of said sub-pixels in each row are repeatedly arranged in the order of at least two first sub-pixels, at least two second sub-pixels and at least two third sub-pixels.

5. The pixel matrix of claim 1, wherein a plurality of said sub-pixels in each row are repeatedly arranged in the order of one first sub-pixel, and one second sub-pixel.

6. The pixel matrix of claim 1, wherein a plurality of said sub-pixels in each row are repeatedly arranged in the order of three first sub-pixels, and three second sub-pixels.

7. An array substrate, comprising a plurality of scanning lines and a plurality of gate lines, the scanning lines are crossed with the gate lines to form a plurality of rectangular areas; each rectangular area is correspondingly provided with one sub-pixel; the sub-pixels are arranged to form the pixel matrix of the claim 1; the pixel matrix comprises a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors; each row comprises said sub-pixels of more than two colors.

8. The array substrate of claim 7, wherein a plurality of said sub-pixels in each row and each line are repeatedly arranged in the order of the first sub-pixels, the second sub-pixels and the third sub-pixels.

9. The array substrate of claim 7, wherein a plurality of said sub-pixels in each row are repeatedly arranged in the order of the first sub-pixels, the third sub-pixels and the second sub-pixels; a plurality of said sub-pixels in each line are repeatedly arranged in the order of the first sub-pixels, the second sub-pixels and the third sub-pixels.

10. The array substrate of claim 7, wherein a plurality of said sub-pixels in each row are repeatedly arranged in the order of at least two first sub-pixels, at least two second sub-pixels and at least two third sub-pixels.

11. The array substrate of claim 7, wherein a plurality of said sub-pixels in each row are repeatedly arranged in the order of one first sub-pixel, and one second sub-pixels.

12. The array substrate of claim 7, wherein a plurality of said sub-pixels in each row are repeatedly arranged in the order of three first sub-pixels, and three second sub-pixels.

13. The array substrate of claim 7, wherein each gate line alternatively powers sub-pixel electrodes on both side.

14. A liquid crystal display, comprising the array substrate of the claim 7, the array substrate comprises a plurality of scanning lines and a plurality of gate lines; the scanning lines are crossed with the gate lines to form a plurality of rectangular areas; each rectangular area is correspondingly provided with one sub-pixel; the sub-pixels are arranged to form the pixel matrix; the pixel matrix comprises a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors; each row comprises said sub-pixels of more than two colors.

15. The liquid crystal display of claim 14, wherein a plurality of said sub-pixels in each row and each line are repeatedly arranged in the order of the first sub-pixels, the second sub-pixels and the third sub-pixels.

16. The liquid crystal display of claim 14, wherein a plurality of said sub-pixels in each row are repeatedly arranged in the order of the first sub-pixels, the third sub-pixels and the second sub-pixels; a plurality of said sub-pixels in each line are repeatedly arranged in the order of the first sub-pixels, the second sub-pixels and the third sub-pixels.

17. The liquid crystal display of the claim 14, wherein a plurality of said sub-pixels in each row are repeatedly arranged in the order of at least two first sub-pixels, at least two second sub-pixels and at least two third sub-pixels.

18. The liquid crystal display of claim 14, wherein a plurality of said sub-pixels in each row are repeatedly arranged in the order of one first sub-pixel, one second sub-pixels and one third sub-pixel.

19. The liquid crystal display of claim 14, wherein a plurality of said sub-pixels in each row are repeatedly arranged in the order of three first sub-pixels, and three second sub-pixels.

20. A driving method of a pixel matrix of claim 1, the pixel matrix comprises a plurality of sub-pixels arranged in rows; the sub-pixels are distinguished in colors, and comprise a plurality of first sub-pixels, a plurality of second sub-pixels and a plurality of third sub-pixels which are respectively corresponding to three primary colors; each row comprises said sub-pixels of more than two colors; when under drive of each scanning line, the gate line corresponding to the sub-pixel electrode of the corresponding color in the current row is driven.

21. The driving method of a pixel matrix of claim 20, wherein a plurality of said sub-pixels in each row and each line are repeatedly arranged in the order of first sub-pixels, second sub-pixels and third sub-pixels.

22. The driving method of a pixel matrix of claim 20, wherein a plurality of said sub-pixels in each row are repeatedly arranged in the order of the first sub-pixels, the third sub-pixels and the second sub-pixels; a plurality of said sub-pixels in each line are repeatedly arranged in the order of the first sub-pixels, the second sub-pixels and the third sub-pixels.

23. The driving method of a pixel matrix of claim 20, wherein a plurality of said sub-pixels in each row are repeatedly arranged in the order of at least two first sub-pixels, at least two second sub-pixels and at least two third sub-pixels.

24. The driving method of a pixel matrix of claim 20, wherein a plurality of said sub-pixels in each row are repeatedly arranged in the order of one first sub-pixel, and one second sub-pixels.

25. The driving method of a pixel matrix of claim 20, wherein a plurality of said sub-pixels in each row are repeatedly arranged in the order of three first sub-pixels, and three second sub-pixels.
